(19) United States
(12) Patent Application Publication
(10) Pub. No.: US 2006/0021622 A1
(43) Pub. Date: Feb. 2, 2006

(54) Bruxism appliance

(76) Inventor: Robert T. Buffington, Chicago, IL (US)

Correspondence Address: BARNES & THORNBURG, LLP, P.O. BOX 2786, CHICAGO, IL, 60690-2786, US

(21) Appl. No.: 10/903,944

(22) Filed: Jul. 30, 2004

(51) Int. Cl. A61C 5/14

(52) U.S. Cl. 128/861

(57) ABSTRACT

Disclosed is a bruxism appliance including a generally U-shaped body having a plurality of apertures therethrough and adapted to be positioned over at least a portion of a first arch of teeth, a first set of bilateral pads disposed on a contact surface of the U-shaped body adjacent to the location of the canines of the first arch of teeth and projecting a first distance beyond the contact surface toward respect teeth of an opposing second arch of teeth, and a second set of bilateral pads disposed on the contact surface of the U-shaped body adjacent to the location of the second molars of the first arch of teeth and projecting a second distance beyond the contact surface toward respect teeth of the opposing second arch of teeth. The apertures are adapted to allow saliva to flow from the interior surface to the exterior surface of the U-shaped body.

### BACKGROUND

This disclosure relates to a device that protects a mandibular structure, and more particularly to a bruxism appliance that protects teeth and prevents tempromandibular disease resulting from bruxism while allowing for the free flow of saliva.

A person suffering from bruxism (“person”), or “teeth-grinding,” generally clenches and grinds his/her teeth while sleeping. Such a person may experience a variety of unpleasant symptoms including, for example, headaches, stiff neck, receding gums, misshapen and misaligned teeth, worn teeth, sleeplessness, tempromandibular disease (TMD) and/or an irritated sleeping partner, to name a few.

Devices that seek to prevent tooth damage and accompanying gum and/or mandibular bone damage resulting from bruxism are known in the art. A person wears such a mouth guard device over his/her teeth while sleeping. Forces generated due to the clenching and grinding of bruxism are then distributed to the night guard rather than directly to the opposing teeth. Although such devices are typically worn over the top teeth, they also include devices worn over the bottom teeth or over both the top and bottom teeth.

Generally, acquiring one of these mouth guard devices requires multiple trips to the dentist over a period of a few weeks. First, a person must visit his/her dentist so that a custom mold of his/her top teeth can be created. Next, the custom mold is sent to a laboratory where is used to create a custom-fit tooth guard. The custom-fit tooth guard is typically made of a hard plastic and may or may not include embedded wires or prongs to ensure a snug fit. Upon completion, the custom-fit tooth guard is sent to the dentist. Subsequently, during a second visit, the custom-fit tooth guard is fitted over the person's top teeth to determine if adjustments are needed. If adjustments are needed, the dentist, using a sanding means or chiseling means suitable for use with the hard plastic material, fine-tunes the exterior surface and/or the interior surface of custom-fit tooth guard.

Unfortunately, in addition to requiring multiple trips to the dentist, custom-fit night guards may be considered costly by some and therefore unavailable to those of limited financial means. In addition, these guards typically need periodic replacement because as the plastic ages, the guards no longer fit or become uncomfortable to wear. In other cases, the person's teeth may shift or change due to age, an accident, braces or other factors. Such a shift or change may necessitate that their existing custom-fit night guard be redesigned and replaced, thereby requiring more time be spent at the dentist and adding further expense. Further, in addition to being somewhat messy, traditional custom-fit night guards encourage the proliferation and build-up of plaque and dental carries due to saliva build-up in their interior region while being worn.

### SUMMARY

The bruxism appliance disclosed herein improves on the prior art in a number of ways. Among other things, it is comfortable, it is inexpensive as compared to traditional custom-fit mouth guards, it does not require multiple trips to a dentist, it is readily adaptable to a person's specific mouth structure, is simple to use and, in some cases, strategically placed padding discourages grinding by applying subtle pressure to selected teeth. In addition, apertures formed in the disclosed bruxism appliance allow for the free flow of saliva, thereby mitigating the proliferation and build-up of plaque and dental carries due to saliva accumulation around the teeth while being worn.

In summary, the bruxism appliance disclosed herein includes a generally U-shaped body having a plurality of apertures therethrough and adapted to be positioned over at least a portion of a first arch of teeth, a first set of bilateral pads disposed on a contact surface of the U-shaped body adjacent to the location of the canines of the first arch of teeth and projecting a first distance beyond the contact surface toward respect teeth of an opposing second arch of teeth, and a second set of bilateral pads disposed on the contact surface of the U-shaped body adjacent to the location of the second molars of the first arch of teeth and projecting a second distance beyond the contact surface toward respect teeth of the opposing second arch of teeth. The apertures are adapted to allow saliva to flow from the interior surface to the exterior surface of the U-shaped body.

In another embodiment, in addition to the U-shaped body having apertures formed therein, the bruxism appliance includes one pad coupled to a center front portion of a contact surface of the U-shaped body, and one set of bilateral pads coupled to the rear portions of the contact surface.

Other objects, advantages and novel features of the present disclosure will become apparent from the following detailed description when considered in conjunction with the accompanying drawings.

### BRIEF DESCRIPTION OF THE DRAWINGS

FIG. 1 is a bottom view of an exemplary bruxism appliance having apertures in accordance with an embodiment of the invention;

FIG. 2 is a perspective view of the exemplary bruxism appliance of FIG. 1;

FIG. 3 is a bottom view of another exemplary bruxism appliance having apertures in accordance with an embodiment of the invention; and

FIG. 4 is a perspective view of the exemplary bruxism appliance of FIG. 3.

### DETAILED DESCRIPTION

While the present disclosure may be susceptible to embodiment in different forms, there is shown in the drawings, and will be described herein in detail, one or more embodiments with the understanding that the present description is to be considered an exemplification of the principles of the disclosure and is not intended to be exhaustive or to limit the disclosure to the details of construction and the arrangements of components set forth in the following description or illustrated in the drawings.

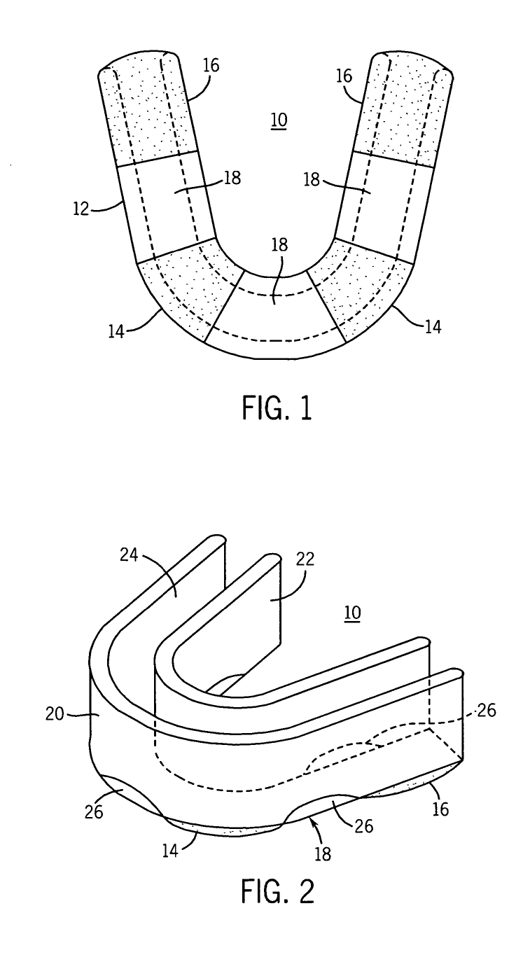

FIG. 1 is a bottom view of an exemplary bruxism appliance 10 having apertures in accordance with an embodiment of the invention. The bruxism appliance 10 includes a generally U-shaped body 12 adapted to be positioned over at least a portion of a first arch of teeth (e.g., a users top teeth). The U-shaped body includes a plurality of apertures formed therein. The bruxism appliance 10 also includes a first set of bilateral pads 14 and a second set of bilateral pads 16 disposed on a selected portion of a contact surface 18 of the U-shaped body 12. In the illustrated example of FIG. 1, the first set of bilateral pads 14 are disposed adjacent to the location of the canines of the first arch of teeth and project a first distance beyond the contact surface 18 toward respect teeth of an opposing second arch of teeth (e.g., a user's bottom teeth). The second set of bilateral pads 16 are disposed adjacent to the location of the second molars of the first arch of teeth and project a second distance beyond the contact surface toward respect teeth of the opposing second arch of teeth.

The first and second distances of pad projection may vary depending on the size of the U-shaped body 12. For example, if the U-shaped body 12 is designed for a small user, the first and second distance (i.e., the height of the respective pad) may be equivalent to 0.5 millimeters, while if the U-shaped body 12 is designed for a large user, the first and second distance may be equivalent to 1.0 millimeters. Other distances are contemplated. In addition, although preferably equal, it is contemplated that the first and second distance may vary with the first distance being slightly greater than the second distance to accommodate the motion of the jaw around a pivot axis.

The U-shaped body 12 and the first and second set of bilateral pads 14, 16 are preferably formed from a polymeric material that is flexible for comfort, yet capable of being trimmed for a customized fit by the wearer. For example, the U-shaped body 12 and the first and second set of bilateral pads 14, 16 may be formed from a flexible ethylene material such as ethyl vinyl acetate manufactured by Keystone Industries. Although formed from the flexible polymeric material disclosed herein, it is contemplated that the U-shaped body 12 and the first and second set of bilateral pads 14, 16 may be formed using any suitable material or combination of materials that is/are both flexible and trim-able. For example, the U-shaped body 12 may be formed from a flexible heat responsive polymeric material that shapes to a user's arch of teeth when heated and then cooled, while the first and second set of bilateral pads 14, 16 may be formed from the ethylene material.

As a result of pad placement on the contact surface 18, when a user inserts the bruxism appliance 10 into his/her mouth on either the top or bottom arch of teeth, depending on the preferred design, the first and second set of pads 14, 16 provide a protective surface against which opposing teeth can contact in the event that bruxism occurs. Moreover, the presence of the first and second set of pads 14, 16 discourages bruxism from occurring. This is due, in part, to the resistance encountered by the teeth when the teeth (e.g., the front central incisors) contact the pad; teeth which “gauge” the hardness of food in an attempt to mitigate jaw trauma due to biting down on something too hard. Although each of the pads of the first set of pads 14 is preferably located adjacent to the canines, it is contemplated that they may be located adjacent to the incisors or the premolars. Similarly, although each of the pads of the second set of pads 16 is preferably located adjacent to the second molars, it is contemplated that they may be located adjacent to the first or third molars.

FIG. 2 is a perspective view of the exemplary bruxism appliance of FIG. 1. As illustrated by FIG. 2, an exterior surface of the U-shaped body 12 includes the contact surface 18 contiguously coupled to a first upstanding side surface 20 and a second upstanding side surface 22. The contact surface 18 and the first and second upstanding side surfaces 20, 22 form an interior surface 24 that generally conforms to the shape of the first arch of teeth where the first upstanding side surface 20 is adapted to correspond to a front surface of the first arch of teeth and the second upstanding side surface 22 is adapted to correspond to a back surface of the first arch of teeth.

In the illustrated example of FIG. 2, a number of apertures 26 are formed in the first upstanding side surface 20 and/or the second upstanding side surface 22 to allow saliva to flow from the interior surface 24 to one of the exterior surfaces of the bruxism device 10. The addition of the apertures 26 enables the free flow of saliva away from the interior surface 24 of the bruxism appliance 10 and therefore discourages saliva accumulation that may potentially cause bacteria and resulting plaque build-up around the teeth. Alternatively or in addition, the apertures 26 may be formed in the contact surface 18 between the first and second set of bilateral pads. The apertures 26 may be formed in one of any number of suitable shapes such as slits or circular holes, to name a few.

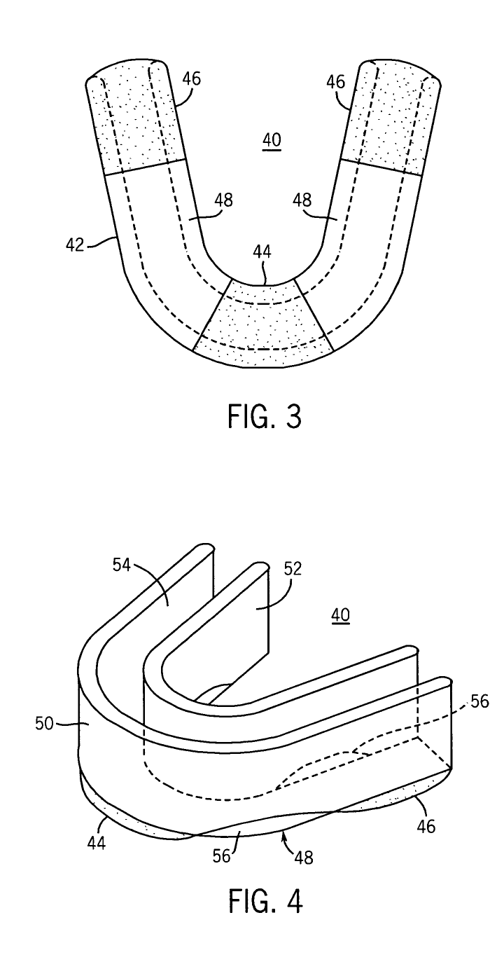

Although two set of bilateral pads 14, 16 are described above, it is contemplated that other pad arrangements may be utilized in connection with the U-shaped body 12. For example, FIG. 3 is a bottom view of another exemplary bruxism appliance 40 having apertures formed therein in accordance with an embodiment of the invention. Like the bruxism appliance of FIGS. 1 and 2, the bruxism appliance 40 includes a generally U-shaped body 42 adapted to be positioned over a portion of either the top or bottom arch of teeth, and may further include a plurality of apertures formed therein to allow for the free flow of saliva. Unlike the bruxism appliance of FIGS. 1 and 2 having the first and second set of bilateral pads 14, 16, the bruxism appliance 40 includes one individual pad 44 and one set of bilateral pads 46 disposed on a contact surface 48 of the U-shaped body 42. The individual pad 44 is preferably disposed adjacent to the location of the central incisors of the arch of teeth and projects a first distance. Each of the pads of the set of bilateral pads 46 is preferably disposed adjacent to the location of the second molars of the first arch of teeth and project a second distance. As described in connection with FIGS. 1 and 2, the placement of the pads can be varied with respect to the individual teeth of the user, depending on the selected design of the bruxism appliance 40. Similarly, the first and second distances may be varied, depending on selected design of the bruxism appliance 40.

FIG. 4 is a perspective view of the exemplary bruxism appliance of FIG. 3. As illustrated by FIG. 4, an exterior surface of the U-shaped body includes the contact surface 48 contiguously coupled to a first upstanding side surface 50 and a second upstanding side surface 52. The contact surface 48 and the first and second upstanding side surfaces 50, 52 form an interior surface 54 that generally conforms to the shape of the first arch of teeth where the first upstanding side surface 50 is adapted to correspond to a front surface of the first arch of teeth and the second upstanding side surface 52 is adapted to correspond to a back surface of the first arch of teeth.

In the illustrated example of FIG. 4, a number of apertures 56 are formed in the first upstanding side surface 50 and/or the second upstanding side surface 52 to allow saliva to flow from the interior surface 54 to one of the exterior surfaces of the bruxism appliance 40. Like the bruxism appliance of FIGS. 1 and 2, the addition of the apertures 56 to the bruxism appliance 40 encourages the free flow of saliva away from the teeth of the user and therefore discourages saliva accumulation in the interior surface 54. Alternatively or in addition, the apertures 56 may be formed in the contact surface 48 between individual pad 44 and the set of bilateral pads 46.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the invention are desired to be protected. The applicant has provided description and figures which are intended as illustrations of embodiments of the disclosure, and are not intended to be construed as containing or implying limitation of the disclosure to those embodiments.

1. A bruxism appliance comprising:
a generally U-shaped body having a plurality of apertures therethrough and adapted to be positioned over at least a portion of a first arch of teeth;
a first set of bilateral pads disposed on a contact surface of the U-shaped body adjacent to the location of the canines of the first arch of teeth and projecting a first distance beyond the contact surface toward respect teeth of an opposing second arch of teeth; and
a second set of bilateral pads disposed on the contact surface of the U-shaped body adjacent to the location of the second molars of the first arch of teeth and projecting a second distance beyond the contact surface toward respect teeth of the opposing second arch of teeth.

2. The bruxism appliance of claim 1, wherein an exterior surface of the U-shaped body comprises the contact surface contiguously coupled to a first upstanding side surface and a second upstanding side surface forming an interior surface therein, wherein the first upstanding side surface is adapted to correspond to a front surface of the first arch of teeth and the second upstanding side surface is adapted to correspond to a back surface of the first arch of teeth, the interior surface of the U-shaped body generally conforming to the shape of the first arch of teeth.

3. The bruxism appliance of claim 2, wherein the plurality of apertures are adapted to allow saliva to flow from the interior surface to the exterior surface of the U-shaped body.

4. The bruxism appliance of claim 2, wherein each of a first number of the plurality of apertures are formed in the first upstanding side surface, and wherein each of a second number of apertures are formed in the second upstanding side surface.

5. The bruxism appliance of claim 2, wherein the each of a third number of the plurality of apertures are formed in the contact surface between the first and second set of bilateral pads.

6. The bruxism appliance of claim 1, wherein the U-shaped body and the first set of bilateral pads and the second set of bilateral pads comprises a flexible polymeric material.

7. The bruxism appliance of claim 6, wherein the surfaces of the U-shaped body and the first set of bilateral pads and the second set of bilateral pads are trimmable by a user seeking a customized fit of the bruxism appliance in the user's mouth.

8. The bruxism appliance of claim 1, wherein the U-shaped body comprises a flexible heat responsive polymeric material that shapes to a user's first arch of teeth in response to heating and then cooling the U-shaped body.

9. The bruxism appliance of claim 1, wherein the first distance is substantially equal to the second distance.

10. The bruxism appliance of claim 1, wherein the first arch of teeth comprise upper teeth of a user of the bruxism appliance.

11. The bruxism appliance of claim 1, wherein the first arch of teeth comprise lower teeth of a user of the bruxism appliance.

12. A bruxism appliance comprising:
a generally U-shaped body adapted to be positioned over at least a portion of a first arch of teeth and having at least one pad for contacting an opposing second arch of teeth and having a plurality of apertures therethrough, the at least one pad located on a contact surface of the U-shaped body and projecting a preselected distance beyond the contact surface toward respect teeth of the opposing second arch of teeth.

13. The bruxism device of claim 12, wherein the at least one pad comprises an individual pad and a set of bilateral pads, the individual pad disposed adjacent to the location of the central incisors of the first arch of teeth and projecting a first distance, the set of bilateral pad being disposed adjacent to the location of the second molars of the first arch of teeth and projecting a second distance.

14. The bruxism appliance of claim 13, wherein a portion of the plurality of apertures are formed in the contact surface between the individual pad and the set of bilateral pads.

15. The bruxism appliance of claim 12, wherein an exterior surface of the U-shaped body comprises the contact surface contiguously coupled to a first upstanding side surface and a second upstanding side surface forming an interior surface therein, wherein the first upstanding side surface is adapted to correspond to a front surface of the first arch of teeth and the second upstanding side surface is adapted to correspond to a back surface of the first arch of teeth, the interior surface of the U-shaped body generally conforming to the shape of the first arch of teeth.

16. The bruxism appliance of claim 15, wherein the plurality of apertures are adapted to allow saliva to flow from the interior surface to the exterior surface of the U-shaped body.

17. The bruxism appliance of claim 15, wherein each of a first number of the plurality of apertures are formed in the first upstanding side surface, and wherein each of a second number of apertures are formed in the second upstanding side surface.

18. The bruxism appliance of claim 12, wherein the U-shaped body and the first set of bilateral pads and the second set of bilateral pads comprise a flexible polymeric material.

19. The bruxism appliance of claim 18, wherein the surfaces of the U-shaped body and the first set of bilateral pads and the second set of bilateral pads are trimmable by a user seeking a customized fit of the bruxism appliance in the user's mouth.

20. The bruxism appliance of claim 18, wherein the surfaces of the U-shaped body are trimmable by a user seeking a customized fit of the bruxism appliance in the user's mouth.

21. The bruxism appliance of claim 12, wherein the first distance and the second distance are substantially equivalent to one millimeter.

22. The bruxism appliance of claim 12, wherein the first distance and the second distance are in a range of about 0.2 to 2 millimeters.

23. The bruxism appliance of claim 12, wherein the first arch of teeth comprises upper teeth of a user of the bruxism appliance.

24. The bruxism appliance of claim 12, wherein the first arch of teeth comprises lower teeth of a user of the bruxism appliance.

25. A bruxism appliance comprising a generally U-shaped body having a plurality of apertures therethrough and adapted to be positioned over at least a portion of a first arch of teeth.

26. The bruxism appliance of claim 25, wherein an exterior surface of the U-shaped body comprises a contact surface contiguously coupled to a first upstanding side surface and a second upstanding side surface forming an interior surface therein, wherein the first upstanding side surface is adapted to correspond to a front surface of the first arch of teeth and the second upstanding side surface is adapted to correspond to a back surface of the first arch of teeth, the interior surface of the U-shaped body generally conforming to the shape of the first arch of teeth.

27. The bruxism appliance of claim 26, wherein the plurality of apertures are adapted to allow saliva to flow from the interior surface to the exterior surface of the U-shaped body.

28. The bruxism appliance of claim 26, wherein each of a first number of the plurality of apertures are formed in the first upstanding side surface, and wherein each of a second number of apertures are formed in the second upstanding side surface.

29. The bruxism appliance of claim 26, wherein the each of a third number of the plurality of apertures are formed in the contact surface.

30. The bruxism appliance of claim 25, wherein the U-shaped body comprises a flexible ethylene material.

31. The bruxism appliance of claim 30, wherein the surfaces of the U-shaped body is trimmable by a user seeking a customized fit of the bruxism appliance in the user's mouth.

32. The bruxism appliance of claim 25, wherein the first arch of teeth comprise upper teeth of a user of the bruxism appliance.

33. The bruxism appliance of claim 25, wherein the first arch of teeth comprise lower teeth of a user of the bruxism appliance.

34. A bruxism appliance comprising:
a generally U-shaped body adapted to be positioned over at least a portion of a first arch of teeth;
a first set of bilateral pads disposed on a contact surface of the U-shaped body adjacent to the location of the canines of the first arch of teeth and projecting a first distance beyond the contact surface toward respect teeth of an opposing second arch of teeth; and
a second set of bilateral pads disposed on the contact surface of the U-shaped body adjacent to the location of the second molars of the first arch of teeth and projecting a second distance beyond the contact surface toward respect teeth of the opposing second arch of teeth.

35. The bruxism appliance of claim 34, wherein an exterior surface of the U-shaped body comprises the contact surface contiguously coupled to a first upstanding side surface and a second upstanding side surface forming an interior surface therein, wherein the first upstanding side surface is adapted to correspond to a front surface of the first arch of teeth and the second upstanding side surface is adapted to correspond to a back surface of the first arch of teeth, the interior surface of the U-shaped body generally conforming to the shape of the first arch of teeth.

36. The bruxism appliance of claim 34, wherein the U-shaped body and the first set of bilateral pads and the second set of bilateral pads comprise a flexible ethylene material.

37. The bruxism appliance of claim 36, wherein the surfaces of the U-shaped body are trimmable by a user seeking a customized fit of the bruxism appliance in the user's mouth.

38. The bruxism appliance of claim 34, wherein the first arch of teeth comprise upper teeth of a user of the bruxism appliance.

39. The bruxism appliance of claim 34, wherein the first arch of teeth comprise lower teeth of a user of the bruxism appliance.

40. The bruxism appliance of claim 34, wherein the first distance and the second distance are in a range of about 0.2 to 2 millimeters.
